(19) United States
(12) Patent Application Publication
(10) Pub. No.: US 2010/0107509 A1
(43) Pub. Date: May 6, 2010

(54) Coated abrasive article for polishing or lapping applications and system and method for producing the same.

(76) Inventor: Olivier L. Guiselin, Dayton, OH (US)

Correspondence Address: Richard L. Sampson;SAMPSON & ASSOCIATES, P.C., 50 Congress Street, Boston, MA, 02109, US

(21) Appl. No.: 12/604,849

(22) Filed: Oct. 23, 2009

Related U.S. Application Data
(60) Provisional application No. 61/110,989, filed on Nov. 4, 2008.

(51) Int. Cl. B24D 3/00; C09K 3/14; B24D 11/00; B32B 5/16

(52) U.S. Cl. 51/298; 51/307; 51/306; 51/308; 51/309; 51/304; 51/303; 51/302

(57) ABSTRACT

An abrasive slurry, abrasive article, and method is provided for forming an abrasive coating on a surface of a backing. The abrasive slurry includes a continuous phase, a first discontinuous phase of abrasive particles dispersed in the continuous liquid phase, and a second discontinuous phase of binder precursor particles dispersed in the continuous liquid phase, so that the continuous liquid phase carries the first and second discontinuous phases. A coated abrasive article is formed by coating the abrasive slurry onto the surface of the backing, and then removing the continuous phase.

### RELATED APPLICATION

This application claims the benefit of U.S. Provisional Application Ser. No. 61/110,989, entitled Lapping and Polishing Formulations, filed on Nov. 4, 2008, the contents of which are incorporated herein by reference in their entirety for all purposes.

### BACKGROUND

1. Technical Field

This invention relates to coated abrasives, and particularly to an abrasive slurry having a binder precursor in a discontinuous phase.

2. Background Information

Throughout this application, various publications, patents and published patent applications are referred to by an identifying citation. The disclosures of the publications, patents and published patent applications referenced in this application are hereby incorporated by reference into the present disclosure.

Coated abrasive articles for polishing or lapping applications are used to work a particulate abrasive material against the surface of a work-piece until the surface has a fine and well controlled finish. Generally it is desirable to attain a very smooth surface finish while obtaining and retaining a high degree of dimensional control so that the resulting product will conform to very precise finish and size standards.

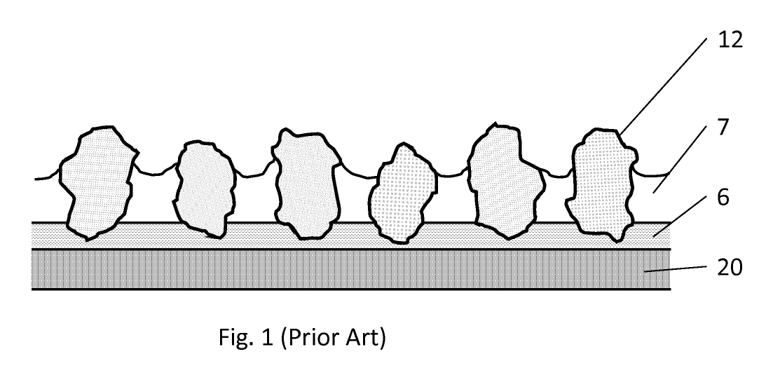

As shown in FIG. 1, most conventional coated abrasives are made by first applying a thin coating of adhesive 6 called a “make coat” to a flexible substrate 20 such as cloth, paper, or polyester film. Abrasive particles 12 are then deposited via a process in which the particles are projected, e.g., electrostatically, onto the make coat. By using an electrostatic field, the particles may be oriented vertically, resulting in a product with a more aggressive cut. A second binder coating 7, called a “size coat”, is applied on top of the particles to firmly anchor the particles to the coated abrasives.

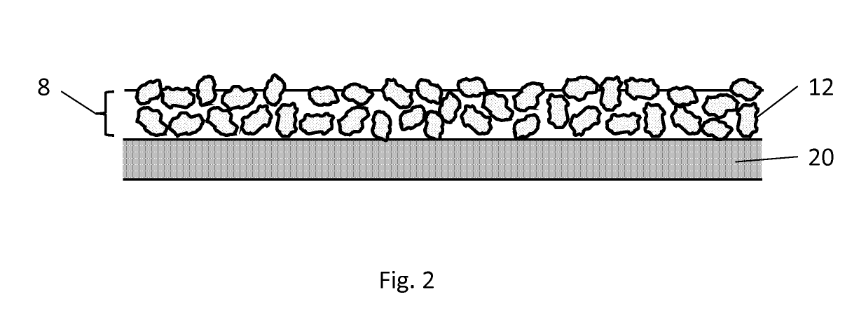

Lapping films are typically made by a slurry coating process. In this process, adhesive binder is dissolved in an organic solvent, blended with filler particles, and deposited as a slurry onto the substrate film 20. The solvent is evaporated, leaving behind the filler and adhesive, which is cured to form a solid coating. The resulting coating 8 contains the abrasive particles 12 oriented in a random fashion, as shown in FIG. 2.

Because of the way they are made, lapping films generally do not cut as aggressively as conventional coated abrasives, but they yield a relatively fine finish. The specific requirements of a given grinding or finishing application dictate whether conventional coated abrasives or lapping films are used; in some cases, both types of product are used.

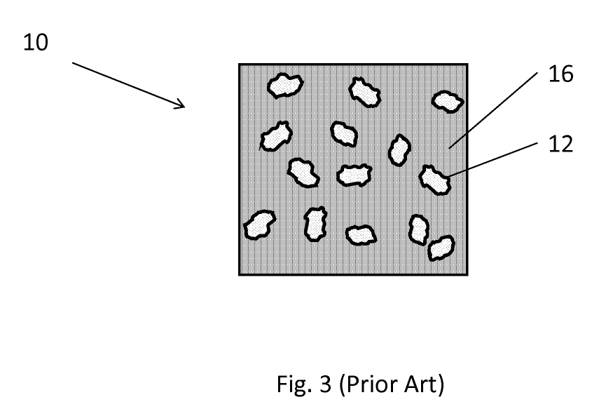

As shown in FIG. 3, conventional slurries 10 used to make lapping films typically consist of an adhesive dissolved in an organic solvent, forming a continuous phase 16, into which the abrasive particles 12 are blended. A key drawback of such a system is that large amounts of solvent are required to dissolve the adhesive and to have a solution that is fluid enough to be coated. It is not unusual to have solvent-adhesive blends in which the adhesive comprises less than 15% by weight of the mix.

One such conventional approach used to manufacture coated abrasive articles for lapping or polishing applications is described in U.S. Pat. No. 7,235,296. The abrasive slurry includes abrasive particles that form a discontinuous phase. The continuous phase is a liquid including an organic solvent such as various alcohols, glycol ethers, glycol ether acetates, lactates, hydrocarbons, ketones, ethers, acetates, methyl ethyl ketone (MEK) or toluene, and a binder precursor.

Another conventional approach is disclosed in U.S. Pat. No. 6,958,082, which teaches the manufacture of a polishing film for the surface finishing of precision instruments such as optical fiber connectors for communications, color filters for LCD, optical lenses, magnetic disk substrates, and semiconductor wafers. Polishing films according to U.S. Pat. No. 6,958,082 are produced by applying a paint like material including ultra fine silica particles (20 nm), a conventional polyurethane or polyester resin binder precursor, and an organic solvent (MEK) on the surface of a plastic film and then drying it to form a polishing layer on the surface of the plastic film.

Conventional lapping film adhesives require relatively large amounts of solvent because of a well-known relationship in polymer science stating that the viscosity of a solution of adhesive polymer is a function of the concentration of the polymer in the solvent and the polymer's molecular weight, both raised to the power 3.4, as shown in the following equation 1 established by G. C. Berry and T. G. Fox in an article entitled “The viscosity of polymers and their concentrated solutions” Adv. Polymer Science Volume 5 pages 261-357 (1968):

η=K(c M)^{3.4} (Eq. 1)

where:

η is the viscosity of the solution,

K is a constant,

c is the concentration of the adhesive polymer in the solution, and

M is the molecular weight of the polymer

Small increases in either concentration or molecular weight result in relatively large increases in viscosity, which can make the coating solution too viscous to coat. It should be noted also that this effect becomes more and more pronounced at higher and higher concentrations or molecular weights. This limits the coating formulator in both the concentration and the molecular weight of the polymer that can be used for the adhesive system. The effect of molecular weight on viscosity thus militates against the use of adhesive systems whose properties may be improved by the use of relatively high molecular weight and/or highly concentrated adhesives.

The consequences of these limitations are significant. The large amounts of organic solvent required pose health, safety, and environmental concerns, including exposure of workers to noxious vapors, risks of fire and explosions, and release of VOCs, which generally require expensive capital investment in incinerators to mitigate, and which still tend to generate a substantial carbon footprint. In recent years environmental and other factors have spurred the coatings industry to use water-based coatings as an alternative to solvent-based coatings. Although a water-based system is in many respects more desirable than a solvent-based system, there are a number of challenges to overcome to make such a system viable. One such challenge is the relatively high surface tension of water, which causes it to bead up rather than spread out and uniformly wet a substrate (most commonly used organic solvents have low surface tensions and do not have this problem). To overcome this, surfactants are generally selected that reduce the surface tension of water and allow it to wet out a substrate. However, many of these surfactants cause excessive foaming. Therefore, another challenge is to reduce or suppress foam. However, most of the anti-foam or de-foaming agents available for water-based systems cause coating defects such as “fisheyes”. Additives can also adversely affect other final properties of the coating; for example, they can reduce adhesion, reduce water resistance, or reduce mechanical properties. These, the aforementioned molecular weight issues, and other technical challenges, can make formulating a viable water-based lapping film slurry formulation a complex and difficult undertaking.

Thus, a need exists for a system and method that addresses the aforementioned drawbacks.

### SUMMARY

### SUMMARY OF THE INVENTION

In a first aspect of the invention, an abrasive slurry is configured to form an abrasive coating on a surface of a backing. The abrasive slurry includes a continuous phase, a first discontinuous phase of abrasive particles dispersed in the continuous liquid phase, and a second discontinuous phase of binder precursor particles dispersed in the continuous liquid phase, so that the continuous liquid phase carries the first and second discontinuous phases.

In a variation of the first aspect of the invention, the continuous phase includes water.

Another aspect of the invention, a coated abrasive article includes a backing having a surface configured for being coated with an abrasive coating. An abrasive coating is disposed on the surface, formed from the abrasive slurry of the first aspect of the invention, or the variation thereof, as described above. The coating includes a coalesced second discontinuous phase in the form of a solid continuous binder phase disposed about the abrasive particles of the first discontinuous phase.

In still another aspect of the invention, a method of manufacturing a coated abrasive article includes providing a backing having a surface configured for being coated with an abrasive coating, and providing an abrasive slurry including a continuous liquid phase, a first discontinuous phase including abrasive particles dispersed in the continuous liquid phase, and a second discontinuous phase including binder precursor particles dispersed in the continuous liquid phase. The abrasive slurry is coated onto the surface of the backing, and the continuous phase is removed, such as by evaporation.

### BRIEF DESCRIPTION OF THE DRAWINGS

### BRIEF DESCRIPTION OF THE DRAWINGS

For a better understanding of the present invention, reference may be made to the accompanying drawing.

FIG. 1 is a cross-sectional schematic view of a coated abrasive product of the prior art;

FIG. 2 is a cross-sectional schematic view of lapping film of the type produced by embodiments of the present invention;

FIG. 3 is a schematic view of an abrasive slurry of the prior art;

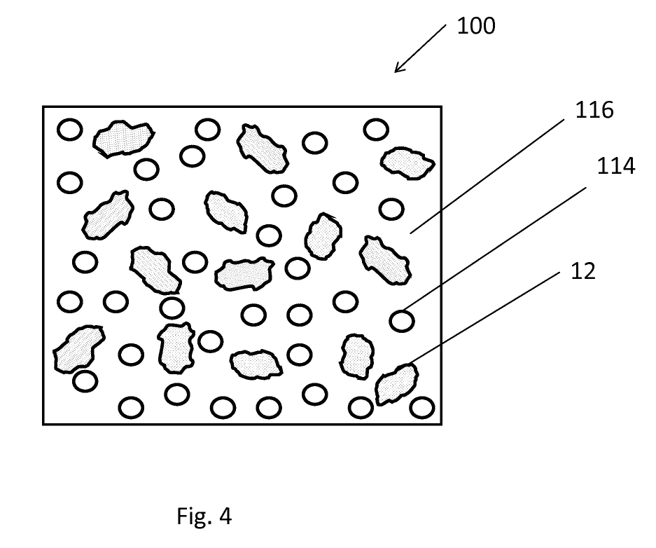

FIG. 4 is a schematic view of an embodiment of the abrasive slurry of the present invention;

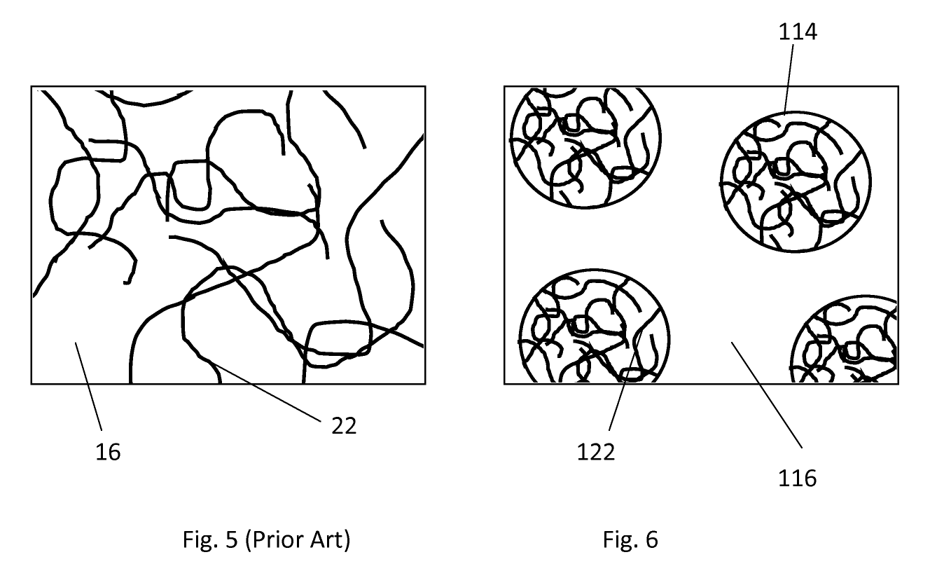

FIG. 5 is a schematic view, on an enlarged scale, of a portion of the abrasive slurry of FIG. 3;

FIG. 6 is a schematic view, on an enlarged scale, of a portion of the abrasive slurry of FIG. 4; and

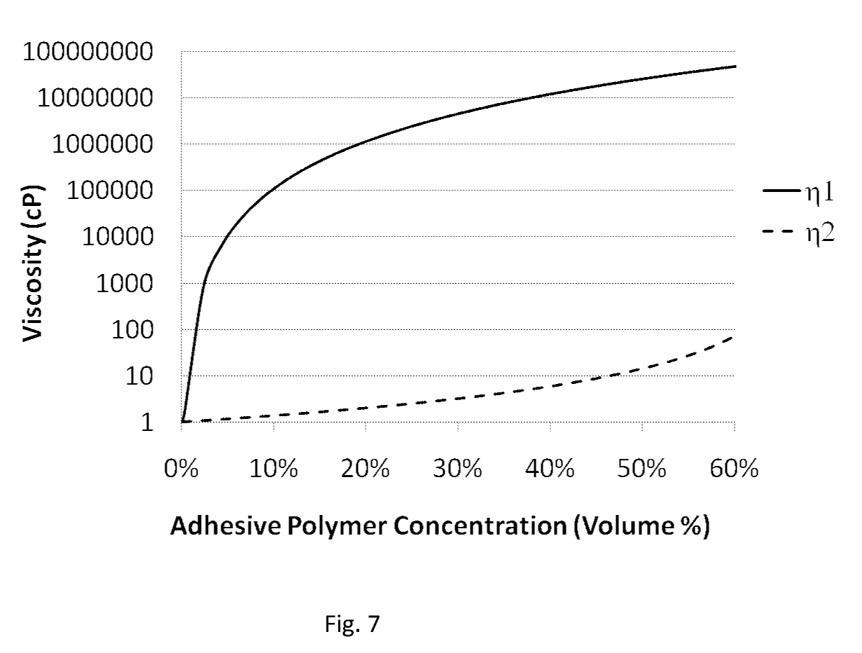

FIG. 7 is a graph of viscosity versus adhesive polymer concentration for the slurries of FIGS. 3 and 4.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

General Overview

Referring to FIG. 3, as mentioned above, coated abrasives adapted for polishing or lapping applications are conventionally derived from a slurry 10, which includes one discontinuous phase (abrasive particles) 12, which is carried by one liquid continuous phase 16. Generally the liquid continuous phase includes a solvent and a resin or other binder precursor that is soluble in the solvent.

In contrast, as shown in FIG. 4, embodiments of the present invention include coated abrasive products for lapping or polishing applications derived from a slurry 100, which includes at least two discontinuous phases (the first discontinuous phase including abrasive particles 12, and the second discontinuous phase including resin particles or other binder precursors 114), which are carried by a liquid continuous phase 116. The liquid continuous phase 116 may be solvent-based, or in particular embodiments, is water-based. Aspects of the invention also include coated abrasives made using this slurry 100, and include methods of coating a substrate (backing) 20 using slurry 100.

Thus, instead of using a slurry in which the adhesive is dissolved into the solvent phase, the instant invention addresses the aforementioned drawbacks of conventional approaches by using a slurry in which the adhesive is dispersed (e.g., as a dispersion or emulsion) as a separate phase in the solvent. As a result, the effects of molecular weight and concentration of the adhesive polymer on the system viscosity are dramatically changed.

Although not wishing to be tied to any particular theory, in the instant embodiments, it is understood that individual adhesive polymer (i.e. binder precursor) molecules 114 are no longer available in the liquid continuous phase 116 to entangle with other polymer molecules 114 and increase viscosity. Instead, the adhesive polymer molecules are grouped in larger domains that are dispersed (or emulsified) in the liquid continuous phase 116. This is believed to substantially sever the direct relationship between viscosity and adhesive polymer molecular weight and concentration commonly associated with the prior art.

Referring now to FIGS. 5 and 6, differences between the prior art system of FIG. 3, and the embodiment of FIG. 4, are shown at a molecular level. FIG. 5 shows dissolved polymer strands 22 entangling with each other, causing the viscosity to rise, while FIG. 6 shows the discrete domains 114 of polymer groups having polymer strands 122 that have significantly less opportunity to entangle with strands 122 of other domains 114.

Because the polymer molecules are arranged in discrete domains 114, the present inventor has realized that the effect of concentration on viscosity in the instant embodiments is characterized by the Maron-Pierce equation (Eq. 2), which is used to describe the viscosity of suspensions:

$$\frac{η}{{η}_{s}} = {( 1 - \frac{c}{0.68} )}^{- 2} \qquad ( Eq . 2 )$$

where:

η is the viscosity of the solution,

ηₛ is the viscosity of the solvent and

c is the concentration of the adhesive polymer in the solution

The graph of FIG. 7 compares the viscosity curves of the conventional system of FIG. 3, in which the adhesive is dissolved in the continuous solvent phase (η1) and of the inventive system of FIG. 4, in which the adhesive is dispersed in discrete domains throughout the solvent phase (η2). As shown, at concentrations above 15% adhesive, the viscosity of the conventional system is too high to be coated by the coating methods well known in the art (500,000 cP). However, when the adhesive is in the form of discrete domains in accordance with the instant invention (dashed line), concentrations of 40% or more adhesive are viable.

Thus, instead of a system in which the adhesive is dissolved into a solvent carrier, embodiments of the present invention provide a system in which the adhesive is dispersed as discrete domains (a “second discontinuous phase”). This approach permits the use of slurries having relatively high solids content (e.g., up to 40% or more)—and consequently significantly lower solvent content—while providing relatively broad formulation latitude by not being limited to adhesives having only relatively low-molecular weights.

Slurries of the present invention may be coated using substantially the same process(es) as used to coat conventional slurries made with dissolved adhesive. Once coated, the product is dried to drive off the coating to permit the adhesive to coalesce to form a continuous coating. This drying may also include curing, such as in the event reactive materials are used, as discussed in greater detail hereinbelow.

In embodiments of the present invention, water may be used as the continuous carrier phase, to provide the added benefit of having a coating free of organic solvent. (It is noted that in some embodiments, a small amount of co-solvent may be included to facilitate processing) This may substantially reduce or eliminate the health, safety, and environmental concerns commonly associated with conventional solvent-based systems, as discussed hereinabove. It is noted that the placement of the adhesive in a second discontinuous phase also enables one to use relatively high molecular weight adhesives (binder precursors) that may substantially mitigate many of the drawbacks associated with the aforementioned conventional water-based systems. Embodiments of the present invention also include coated abrasive articles for lapping or polishing applications, which are manufactured by coating the waterborne abrasive slurry of the invention onto a backing and drying/curing the slurry. Embodiments also include methods of making the abrasive articles.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

Where used in this disclosure, the term “Binder” refers to the composition which binds abrasive particles to a backing in the final product. “Binder precursor” refers to the components of the binder as they exist in the slurry prior to drying and/or curing of the coating. Thus, as used herein, the terms “binder” and “binder precursor” refer to substantially any material capable of securing the abrasive particles to the backing, including adhesives, resins, polymers, oligomers, pre-polymers, glues, bonds, etc. The terms “slurry” or “abrasive slurry” refer to a coatable liquid composition that includes a liquid carrier, abrasive particles and binder precursor particles dispersed in the liquid carrier, and optionally additional additives. The term “surfactant” refers to a surface active agent which migrates to the interface between two phases. The term “dispersant” refers to a surfactant configured to disperse a discontinuous phase in a liquid carrier. The terms “water-based” and “waterborne” refer to a composition in which the liquid continuous phase comprises water as the primary constituent. The term “organic solvent” refers to any liquid whose molecules comprises at least one carbon atom. The term “solvent-based” refers to a composition in which the liquid continuous phase comprises organic solvents as primary constituents. The term “abrasive slurry base” refers to an abrasive particle dispersion, which may include water or other solvents as the liquid carrier, and includes dispersed abrasive particles, and optionally additives such as for example, dispersants, foam control agents, inorganic pigments, inorganic fillers, adhesion promoters, viscosity modifiers, but little or no binder precursor particles. The terms “binder precursor liquid composition” and “resin liquid composition” refer to a binder precursor dispersion, emulsion, or colloidal suspension with particles ranging in size from 5 nm to 50 microns and in either liquid or solid state. The binder precursor liquid composition includes a liquid carrier such as water or other solvents, dispersed binder precursor particles, and optionally additives such as surfactants and/or dispersants to stabilize the binder precursor particles, foam control agents, co-solvents, coalescing agents, organic pigments, and soluble adhesion promoters, but no abrasive particles. A wide range of resin dispersions, emulsions, or colloidal suspensions may be used as the binder precursor liquid composition.

Having generally described embodiments of the invention, specific aspects of the invention will now be described in greater detail.

Particular embodiments of an abrasive slurry according to this invention include the following:
A waterborne continuous liquid phase including water, which acts as carrier. In addition this phase may contain various additives which are soluble in water such as a small amount of co-solvent.
A first discontinuous phase formed by abrasive particles dispersed in the continuous phase. Dispersants may be used to properly disperse the abrasive particles in water. This first discontinuous phase may also include fillers or secondary abrasive particles if necessary.
A second discontinuous phase made of binder precursor particles dispersed in the continuous phase. Surfactants, charged polymer end groups, or polymeric dispersants may be used to stabilize the binder precursor particles in the continuous phase. The binder precursor can be a reactive binder precursor such as thermosetting binders, crosslinking binders, and binders curable by an additional polymerization, or a non-reactive binder precursor such as a thermoplastic polymer that needs only drying, without additional reactive curing, to solidify.
Additional optional additives such as curing agents, coloring agents (e.g., pigments, dyes, etc.), wetting agents, foam control agents, water compatible adhesion promoters, viscosity modifiers, acids, bases, or buffers to control pH, film coalescing agents, antistatic agents, etc. may be incorporated into the slurry. Additives such as dispersants, coupling agents, fillers, curing agents, hardening agents, photo-initiators, surfactants, wetting agents, coloring agents (e.g., pigments, dyes), anti-oxidants, antistatic agents, etc.

The water based slurry may be uniformly applied over a flexible backing 20 by a variety of methods, including gravure roll coating, curtain coating, slot die coating, knife coating, spray coating, or any other coating method known in the art, and then dried/cured.

Coated abrasives in accordance with the present invention have been found to have surprisingly good coating quality and performance for lapping or polishing applications. In addition, the slurry of the invention is environmentally attractive and cost effective since:
The waterborne process of the invention has relatively low VOC (Volatile Organic Compound) content.
The waterborne slurry process requires substantially no abatement or solvent recovery equipment and thus generally requires a lower capital investment than prior solvent-based approaches.
The second discontinuous phase enables the use of high molecular weight resins without the adverse effects on viscosity as discussed hereinabove.

Abrasive Article Backing

Embodiments of the present invention may be applied to substantially any type of backing (substrate) 20. Such suitable backings include polymeric film, cloth, paper, nonwovens, open mesh, foams, metallic foil, and combinations thereof. Examples of polymeric films include, but are not limited to, polyester, polyester and co-polyester, microvoided polyester films, PEN, polyimide films, polyamide films, polyvinyl alcohol films, polypropylene film, polyethylene film and the like. In particular embodiments, a treatment may be applied to the backing/substrate 20 for better adhesion. Typical examples of treatments include surface alterations such as corona treatment, UV treatment, electron beam treatment, flame treatment, scuffing, and primer coatings.

The backing 20 should be sufficiently strong to support the binder and abrasive particles. Additionally it should be sufficiently flexible to allow mounting on the surface of the particular tool (e.g., polishing or lapping tool) of interest. Generally it is desirable that the backing be smooth and of uniform caliper in embodiments intended for finishing high precision articles.

Abrasive Particles

A wide range of abrasive particles may be used in the various embodiments of present invention, and may be classified as follows:
Superabrasive particles such as natural diamond, synthetic diamond, and cubic boron nitride.
Hard abrasive particles such as aluminum oxide, heat treated aluminum oxide, white fused aluminum oxide, black silicon carbide, green silicon carbide, titanium diboride, boron carbide, tungsten carbide, titanium carbide, garnet, fused alumina zirconia, sol gel abrasive particles and the like.
Soft abrasive particles such as silica, silicates, iron oxide, zirconium oxide, titanium dioxide, and tin oxide.
Chemically reactive abrasive particles such as cerium oxide, rare earth compounds, zirconium oxide, chromium oxide, or mixtures thereof. It is believed that such chemically reactive abrasive particles may provide a chemo-mechanical element to the polishing procedure. As used herein, chemo-mechanical refers to a dual mechanism where corrosion chemistry and fracture mechanics may both play a role in glass polishing. Chemically reactive abrasive particles may be especially useful in glass polishing operations.

The average size of the abrasive particles may vary between 5 nanometers and 200 micrometers, and more typically, between 10 nanometers and 100 micrometers. In particular embodiments it may be desirable to use a relatively tightly graded particle size distribution, or use a blend of particle sizes, or a blend of particle types, or combinations thereof, to achieve particular finish or performance effects.

It is also within the scope of this invention to use surface treated abrasive particles. The surface treatment may be used to increase the adhesion to the binder and alter the abrading characteristics of the abrasive particles.

Still further, in some embodiments of this invention, the first discontinuous phase may include aggregates of smaller primary abrasive particles.

Binder Precursors

In particular embodiments, the binder precursor particles 114 should be more than 5 nm in size (e.g., in their largest dimension). Generally, the binder precursor particles size is less than 50 microns, preferably less than 10 microns, and more preferably less than 2 microns. Specific examples of suitable binder precursor liquid compositions for this invention have a particle size between 50 and 500 nanometers.

The binder precursor particles 114 may include monomers, oligomers, pre-polymers, or polymers.

The binder precursor may be reactive and have functional groups such as vinyl, alcohol, methylol, aldehyde, ketone, phenol, ester, epoxy, acyl halide, carboxylate, amide, amine, imine, nitrile, isocyanate, thiol, sulfonyl, acrylate, methacrylate, silanol, and any other functional group or combinations thereof used in the art.

Additionally the binder precursor may also be a thermoplastic polymer.

The physical state of the binder precursor particles may be liquid or solid. The binder precursor particles may be prepared by emulsion polymerization, emulsification (e.g., using any number of conventional emulsifying agents), self-emulsification, dispersion, and related methods in the art. The term “emulsion” generally refers to a system of non-soluble liquid droplets within a continuous liquid phase, while the term “dispersion” generally refers to a system of solid particles in a liquid continuous phase. Additionally, the term “emulsion” may also refer to a dispersion of solid particles produced by emulsion polymerization. In this patent, the terms “emulsion” and “dispersion” will be used interchangeably to refer to a system of either solid particles or liquid droplets in a continuous liquid phase.

The binder precursor may be dispersed in the continuous phase by means of a surfactant adsorbed from the surrounding continuous phase onto the surface of the binder precursor particles or by means of a surfactant group grafted to or incorporated within the backbone of the polymer chains comprising the binder precursor. The term “external surfactant” refers to the former type of surfactant (adsorbed to the surface of the particles) while the term “internal surfactant” refers to the latter type of surfactant (grafted to the backbone of the polymer).

A broad range of waterborne resin liquid compositions may be used as a liquid composition of binder precursor 114. Acrylic (co)-polymer emulsions, hydroxyl-functional acrylic copolymer emulsions, styrene butadiene emulsions, polyurethane dispersions, urethane-acrylic co-polymer dispersions, urethane-acrylic hybrid dispersions, polyester dispersions, polyester urethane dispersions, acrylic alkyd copolymer dispersions, epoxy dispersions, phenoxy dispersions, epoxy novolac dispersions, acrylate-functional radiation-curable resin dispersions, and amine-functional resin dispersions are examples of binder precursor 114 compositions suitable for embodiments of this invention.

Resin liquid compositions are characterized by the size and morphology of the resin particles, the type of surfactants or dispersants used to stabilize the resin particles, the quantity of chemical reactive groups (i.e. acid number, epoxy number, hydroxyl number, amine number), the molecular weight of the polymer inside the resin particle, the film forming temperature, the glass transition temperature of the polymer (Tg), the physical properties of the coating after drying (hardness, impact resistance, % elongation, modulus, tensile strength), their adhesion to various substrates, etc.

In certain embodiments of this invention, two or more resin compositions may be blended together to achieve a desirable set of properties, for example hardness, Tg, or elongation.

In some embodiments the resin liquid composition (resin dispersion) may have a core-shell structure. Copolymers designed with a hard, glass like core and a soft rubbery shell will show a lower minimum film forming temperature at a comparable coalescent level than a physical blend of the same composition. In some embodiments, the use of a hydrophobic core and hydrophilic shell formed of alkaline soluble polymer chains modified with hydrophobic components to make them relatively highly surface active allows the production of surfactant free resin dispersion (AJP Buckmann et. al., “Self-Crosslinking Polymeric Dispersants and their Use in Emulsion Polymerization”, presented at International Waterborne, High Solids, and Powder Coatings Symposium, Symposium Sponsored by the University of Southern Mississippi, Dept. of Polymer Science, Feb. 6-8, 2002, New Orleans, La., USA).

Some examples include commercially available acrylic dispersions (produced by emulsion polymerization) available from HEXION (under the trademark AQUAMAC™), LUBRIZOL ADVANCED MATERIAL Inc. (under the trademarks CARBOSET® and HYCAR®), DSM NEORESINS (under the trademark NEOCRYL®), REICHHOLD INC (under the trademark AROLON®), BASF (under the trademark ACRONAL®), and other manufacturers worldwide. Other examples include polyurethane dispersions from BAYER (under the trademark DISPERCOLL U), LUBRIZOL ADVANCED MATERIAL Inc. (under the trademarks SANCURE®), DSM NEORESINS (under the trademark NEOREZ®), REICHHOLD INC (under the trademark UROTUF®), BASF (under the trademark LUPHEN®), and other manufacturers worldwide.

Further examples include urethane-acrylic copolymer dispersions and urethane-acrylic hybrid dispersions available from AIR PRODUCTS (under the trademark HYBRIDUR®), DSM NEORESINS (under the trademark NEOPAC®), and other manufacturers worldwide.

Further still, suitable epoxy dispersions are available from HEXION (under the trademark EPIREZ™), and other manufacturers worldwide. There are many types of epoxy dispersions such as for example aqueous dispersion of a liquid Bisphenol A epoxy resin, aqueous dispersion of a solid Bisphenol A epoxy resin, aqueous dispersion of an epoxidized Bisphenol A novolac resin, aqueous dispersion of a urethane modified epoxy resin, aqueous dispersion of a butadiene-acrylonitrile modified epoxy resin, aqueous dispersion of an epoxidized o-cresylic novolac resin.

Additionally, waterborne radiation curing resin dispersions from suppliers such as SARTOMER, UCB RADCURE, or INCOREZ may be suitable for this invention. These resin dispersions include acrylate functional resins, which are dried prior to crosslinking by such means as electron beam, UV, or other suitable methods.

In some embodiments the resin dispersion includes inorganic particles, which are encapsulated in the resin particles or bound to the resin particles. These inorganic particles may act as fillers or abrasive particles. The introduction of these inorganic particles may be made by the resin supplier during the emulsion polymerization process. Examples of inorganic/organic latex composites have been described in the scientific literature by (Adeline Perro et al, “Synthesis of Hybrid Colloids through the Growth of Polystyrene Latex Particles onto Methacryloxy methyl triethoxysilane—Functionalized Silica Particles” MRS Symposium Proceedings (2006).

Dispersants to Disperse the Abrasive Particles

In particular embodiments, the abrasive particles are dispersed in a liquid carrier including water prior to the addition of the binder precursor. The use of a dispersant is desired to achieve abrasive particle dispersion, and prevent agglomeration and settling. This is usually accomplished by one or both of two mechanisms: electrostatic repulsion and/or stearic hindrance. A wide range of dispersants may be used depending on the type and size of the abrasive particles.

Anionic surfactants containing carboxylate, sulfonate, sulfate, phosphate, and/or phosphonate groups may be used. For example, 2-phosphonobutane 1,2,4 tricarboxylic acid tetrasodium salt (PBTC-Na4), or 4,5 dihydroxy-m-benzenedisulfonic acid disodium salt (TIRON) may be used to disperse fine alumina powders in water as disclosed in patent EP 1529764.

Nonionic surfactants, such as the large number of widely available adducts of ethylene oxide and block polymers of ethylene oxide and propylene oxide, may be used to disperse the abrasive particles. Nonyl phenol ethoxylate is typical example of such surfactants.

Polymeric dispersants have a significantly higher molecular weight than conventional dispersants. Polymeric dispersant contains polymeric chains for stearic stability in solution, and pendant anchoring groups, which absorb onto the surface of the abrasive particles.

In some instances, anionic polymeric dispersants, with molecular weight higher than 500 and an acid value higher than 0 such as PAA (polyacrylic acid), or PCA (copolymer of phosphono & carboxylic acid), may be used to disperse the abrasive particles.

Cationic surfactants or polymeric cationic dispersants may also be used to disperse the abrasive particles, provided that the resin dispersion is stabilized by nonionic surfactants or cationic surfactants. If the dispersant used to disperse the abrasive particles is not compatible with the resin dispersion, the abrasive slurry may agglomerate.

In addition, surfactants (e.g., dispersants) may be used to disperse other discontinuous phase in the slurry, including fillers, pigments, and other additives not soluble in the continuous phase.

Curing Agents, Cross-Linking Agents, and Hardeners

Optionally, curing agents, cross-linking agents, or hardeners may be used to enhance binder properties by chemically bonding polymer chains and forming a cross-linked network. Appropriate curing agents for different resin systems are well-known in the industry. Suitable curing agents include, but are not limited to, the following, including combinations thereof: metal ion crosslinkers, amines, peroxides, aziridines, isocyanates, dicyandiamines, imidazoles, silanes, and photoinitiators.

In particular embodiments of this invention, a metal ion crosslinker such as BACOTE 20 from MEI CHEMICALS may be used to crosslink carboxyl or hydroxyl functional resins such as acrylic or urethane dispersions. BACOTE 20 is an alkaline solution of stabilized ammonium zirconium carbonate containing anionic hydroxylated zirconium polymers. It is believed that BACOTE 20 functions by the generation of cationic zirconium resulting from decomposition during drying.

In various embodiments of this invention, a water dispersible aliphatic or aromatic polyisocyanate, such as DESMODUR DN, DESMODUR DA-L, or BAYHYDRUR XP-7063 sold by BAYER, is combined with a hydroxyl-functional acrylic copolymer emulsion, a hydroxyl-functional polyurethane dispersion, or an aliphatic polyester polyurethane dispersion.

In some embodiments of this invention, a micronized grade of dicyandiamine such as DICYANEX® 1400B from AIR PRODUCTS, an aqueous solution of 2-ethyl-4-methyl imidazole such as IMICURE EMI-24 from AIR PRODUCTS, 2-methylimidazole powder from BASF, a modified polyamidoamine adduct such as EPIKURE™ 8536-MY-60 from HEXION, or a water dispersion of a modified polyamide adduct such as EPIKURE™ 6870-W-53 from HEXION may be combined with a waterborne epoxy dispersion.

In some embodiments of this invention, a silane such as β-(3,4-Epoxycyclohexyl)ethyltriethoxysilane available from ACC SILICONES under the trademark SILQUEST 186 may be used to crosslink carboxyl functional latexes, urethane dispersions, urethane acrylic hybrid dispersions. The epoxy portion of the molecule reacts with the matrix resin and the alkoxysilane portion crosslinks after hydrolysis by condensation, forming siloxane bonds.

In various embodiments of this invention, the use of two or more crosslinking agents may be used. This may be desirable if two chemically different resin dispersions are used such as for example an acrylic emulsion together with an epoxy dispersion.

In specific embodiments, a photo-initiator such as DURACURE 1173 or IRGACURE 651 from CIBA is combined with a waterborne radiation curable resin such as NEORAD NR-440 from DSM NEORESIN.

Coalescing Agents and Co-Solvents

The continuous phase 116, in addition to water, may include various coalescing agents and/or co-solvents to improve the coating quality and help the discontinuous binder precursor particles to coalesce into a continuous binder phase during drying. Hydrophobic solvents such as ethylene glycol monobutyl ether, dipropylene glycol n-butyl ether, tripropylene glycol n-butyl ether, and 2 2 4 trimethyl 1 3 pentanediol monoisobutyrate, and hydrophilic solvents such as N-methylpyrrolidone (NMP) are often used.

Foam Control Agents

The continuous phase 116, in addition to water, may include various additives, such as foam control agents. In this regard, the presence of surfactants and chemical agitation under shear tends to facilitate the production of the binder precursor liquid composition 10 and/or the abrasive slurry. However, this process may generate macro foam and/or micro foam due to entrapped air. Entrapped air/foam may cause various quality issues. Macro foam may lead to coating defects such as non uniform appearance, streaks, pinholes, while micro foam may generate micro pinholes in the coating.

Waterborne abrasive slurries are generally more sensitive to foam than solvent-based systems due to the presence of surfactants, dispersants, and wetting agents (discussed in greater detail hereinbelow) in the water. In solvent-based abrasive slurries the organic solvent often acts as an anti-foaming agent. In waterborne solutions, foam may be generated at each step of the production process due to mechanical agitation:
Air entrapment during the mixing process to prepare the coating formulation.
Air entrapment during the coating process (described hereinbelow) when the abrasive slurry 100 is applied on the backing 20 by roll coating, knife over roll coating, spray coating, or when the abrasive slurry is pumped or otherwise handled.

A wide variety of suitable foam control agents are available for waterborne systems from many sources. Foam control agents are sometimes called de-aerators, defoamers, or anti-foaming agents. Quite often foam control agents are proprietary blends of various ingredients such as water, mineral oils, fatty oils, vegetable oils, silicone oils, glycols, alcohols, hydrophobic silica derivatives, hydrophobic organic solids, surfactants, surface active compounds, and the like. Foam control agents may also be based on low molecular weight surfactants.

In particular embodiments of this invention, a combination of two or more foam control agents may be used in the slurry base and/or the resin blend.

Wetting Agents

Due to its high surface tension, water has an influence on the quality of waterborne coatings. Wetting agents are surfactants commonly used to enhance wetting and minimize coating defects such as non-wets, fisheyes, craters, or dimples.

Many wetting agents such as hydrocarbon based surfactants, silicone surfactants, non ionic fluoropolymer surfactants, polyester-modified siloxanes, and monomeric surfactants may be used to lower the surface tension of the abrasive slurry. In certain embodiments of this invention, fluoro surfactants such as ZONYL and CAPSTONE from DUPONT and NOVEC from 3M may be used to lower the surface tension of the abrasive slurry.

Rheology Modifiers

In certain embodiments of this invention, the abrasive slurry may be diluted by water or other solvents to adjust the solids loading of the abrasive slurry and thus control the thickness of the abrasive coating after drying. The use of rheology modifiers may be desired to prevent settling of the abrasive particles and to modify the rheology of the coating solution to optimize the coating conditions.

Rheology modifiers may be classified into several categories:
Associative thickeners: These rheology modifiers are usually water soluble polymers capped with water insoluble hydrophobic groups. The primary thickening mechanisms is due to intermolecular associations. This group includes the following:
   HASE: hydrophobically modified alkali acrylic emulsions,
   HEUR: hydrophobically modified ethylene oxide urethane rheology modifiers,
   HEURASE: hybrid HASE/HEUR rheology modifiers consisting of terpolymers of a carboxyl functional monomer, a water insoluble monomer, and a urethane exothylate monomer with a hydrophobic tail,
   HEAT: hydrophobically modified ethoxylated aminoplast thickeners, and
   HMHEC: hydrophobically hydroxyethyl cellulosic thickeners.
Non associative thickeners that interact with the water phase: This group includes cellulosic thickeners, and acrylics. Cellulosic thickeners include methyl cellulose (MC), hydroxyethyl cellulose (HEC), ethyl hydroxyethyl cellulose (EHEC), hydroxypropyl cellulose (HPC), hydroxypropyl cellulose (HPC), hydroxypropyl methyl cellulose (HPMC), and hydrophobically hydroxyethyl cellulose (HMHEC). Acrylics include acid or salt forms of water-soluble acrylates, polyacrylic acids, and aramid pulp.
Inorganic thickeners, including clays, fumed silica, and overbased calcium sulfonate gels. Clays include smectite clays such as bentonite, hectorite, or montmorillonite, kaolin, mica, and attapulgite. Fumed silica is available in a wide variety of forms including hydrophobically treated versions using silanes, siloxanes, or silazanes.
Other rheology modifiers include castor oil derivatives, carboxylic acid derivatives, polyamides, and polysaccharides.

In certain embodiments of this invention, a low molecular weight acrylic copolymer offered at 100% solids and soluble in alkaline water sold by LUBRIZOL under the trademark CARBOSET® 515 is added to the abrasive slurry to promote dispersion, leveling, flow and adhesion.

In certain embodiments of this invention, AQUAFLOW® NLS-200, a hydrophobically modified polyacetal polyether from HERCULES INC is added to the abrasive slurry to provide low to medium shear viscosity along with excellent flow and leveling. A nonanionic associative thickener AQUAFLOW® NHS-300 may also be added to the abrasive slurry to increase high shear viscosity.

Other Additives

The abrasive slurry of this invention may further include water soluble adhesion promoters such as silanes, zirconates or titanate coupling agents, antistatic agents, inorganic pigments such as TiO2, organic pigments, UV stabilizers, anti-oxidants, grinding aids, biocides, fluorescent additives, etc. The amounts of these materials are selected to provide the desired performance.

The abrasive slurry may also include fillers. Fillers are generally inorganic particles with a smaller particle size or a lower hardness than the abrasive particles. They can be used to modify the performance of the abrasive coating or reduce the raw material cost.

Method of Manufacturing the Coated Abrasive Article for Lapping or Polishing Applications

In particular embodiments of this invention, an abrasive slurry base is prepared by adding the abrasive particles 12 to liquid carrier, e.g., water, optionally with a dispersant, and/or a foam control agent. A conventional milling procedure may then be used to disperse the abrasive particles within the liquid carrier to form an abrasive slurry base.

A binder precursor liquid composition may be prepared separately, by mixing one or more resin compositions with one or more of various additives such as anti-foaming agents, pigments, water soluble adhesion promoters, co-solvent(s), and dilution water. The binder precursor liquid composition as well as the aforementioned additives may then be added to the abrasive slurry base to form the abrasive slurry of the invention.

A representative process for producing an embodiment of a coated abrasive product of the invention then includes the following:
Providing a backing 20 having a surface configured for being coated with an abrasive coating;
Providing an abrasive slurry 100 including a continuous liquid phase 116 (e.g., including water), a first discontinuous phase including abrasive particles 12 dispersed in the continuous liquid phase, and a second discontinuous phase including binder precursor particles 114 dispersed in the continuous liquid phase;
Coating the abrasive slurry onto at least one side of the backing 20 for example by spray coating, roll coating, gravure coating, offset gravure coating, reverse gravure coating, knife over roll coating, slot die coating, or curtain coating;
   Removing the liquid carrier in the continuous phase 116, e.g., by evaporation, e.g., by drying in an oven; and
   Coalescing the binder precursor 114 of the discontinuous phase to form a solid continuous phase around the abrasive particles 12;
and optionally, curing or crosslinking the binder using an energy source such as hot air, e-beam, X-ray, UV light, infrared light, microwave, a combination thereof, or any other crosslinking method known in the art.

For effective abrasive properties, the mass (weight) ratio of abrasive particles to binder precursor should be between 0.07 and 11, more typically between 0.13 and 7, and even more preferably between 0.20 and 5.5. The mass ratio of continuous phase to the sum of all discontinuous phases (abrasive, binder precursor, non-soluble additive, etc.) should be between 0.4 and 20, more typically between 0.6 and 12, and even more preferably between 0.8 and 7. For effective abrasive properties, the slurry may be configured so that the coating on the finished abrasive article may include anywhere between 7% and 94% per weight of abrasive particles, and more typically, from 12% to 88% per weight of abrasive particles, and even more preferably from about 18% to about 85% per weight of abrasive particles.

The coated abrasive article may then be converted into various shapes such as discs, sheets, rolls, or other forms used in the art, such as discs laminated to pressure-sensitive adhesives, to meet customer requirements.

The following illustrative examples demonstrate certain aspects and embodiments of the present invention, and are not intended to limit the present invention to any one particular embodiment or set of features.

### Examples

TABLE
Materials and Sources

| Material Name | Description | Source |
|---|---|---|
| E-600 | High purity sub-micron calcined | Saint-Gobain Ceramics & |
| | aluminum oxide powder | Plastics, Inc |
| | with particle size of 0.3 μm. | Worcester, MA |
| DISPERBYK 190 | Dispersant | BYK USA |
| | | Wallingford, CT |
| Methylimidazole | Imidazole epoxy curing agent | PCI Synthesis |
| | | Newburyport, MA |
| EPIKURE ™ 3072 | Curing agent for epoxy resin | Hexion Specialty Chemicals |
| | | Houston, TEXAS |
| Epirez 5003-W55 | Waterborne epoxy dispersion | Hexion Specialty Chemicals |
| | | Houston, TEXAS |
| NEOPAC R9000 | waterbased acrylic/urethane | DSM NEORESINS INC. |
| | dispersion | Wilmington, MA |
| NeoCryl ® curing agent | Crosslinker | DSM NEORESINS INC. |
| | | Wilmington, MA |
| 9 μm Aluminum oxide | Aluminum oxide abrasive particles | Fujimi Corporation |
| | | Tualatin, OR |
| 30 μm Aluminum oxide | Aluminum oxide abrasive particles | Fujimi Corporation |
| | | Tualatin, OR |
| ACRYSOL ASE | alkali soluble, acrylic thickener | ROHM & HAAS |
| | | Philadelphia, PA |
| Neocryl A-662 | Acrylic dispersion | DSM NEORESINS INC. |
| | | Wilmington, MA |
| ZONYL FSO | Wetting agent | DUPONT COMPANY |
| | | Wilmington, DE |
| NEOREZ R-9679 | Urethane dispersion | DSM NEORESINS INC. |
| | | Wilmington, MA |
| BYK-024 | Foam control agent | BYK USA |
| | | Wallingford, CT |
| 9 μm diamond | Diamond abrasives particles | Warren Amplex |
| | | Olyphant, PA |
| TAMOL | Dispersant | ROHM & HAAS |
| | | Philadelphia, PA |
| 3 μm silicon carbide | Silicon carbide abrasive particles | Fujimi Corporation |
| | | Tualatin, OR |
| 9 μm silicon carbide | Silicon carbide abrasive particles | Fujimi Corporation |
| | | Tualatin, OR |

### Example 1

### Lapping Films with 0.3 Micron Aluminum Oxide Particles

Preparation of the Abrasive Slurry Base: Approximately 7.5 kg of 3 mm diameter Yttria-stabilized zirconia beads available from TOSOH was put into a one gallon ball-milling jar. 1000 grams of an alumina powder (E-600) from Saint-Gobain having a particle size around 0.3 micron, 560 grams of de-ionized water, and 40 grams of DISPERBYK 190 were added to the milling jar. The mixture was milled for 60 minutes.

Preparation of the Binder Precursor Liquid Composition 11:

40 grams of EPIKURE™ 3072 and 0.67 grams of Methylimidazole were added to 230 gram of resin Epirez 5003-W55 from Hexion. The mix was stirred for 10 minutes using a laboratory mixer.

Preparation of the Abrasive Slurry 11:

50 grams of the binder precursor liquid composition and 51 grams of the abrasive slurry base were combined into a 200-ml beaker and stirred with a laboratory mixer for 5 minutes.

Preparation of the Binder Precursor Liquid Composition 12:

5 grams of NEOCRYL curing agent was added to 100 grams of Neopac R-9000 under agitation in a laboratory mixer.

Preparation of the Abrasive Slurry 12:

50 grams of the binder precursor liquid composition 12 was added to a 200-ml beaker and agitated with a laboratory mixer. 91 grams of the abrasive slurry base was added to the beaker and mixed for 5 minutes.

Coated Abrasive Sample Preparation:

The abrasive slurries 11 & 12 were coated on a 3 mil thick PET film using a #18 Meyer rod, and then dried and cured in an oven at 300° F. for 100 minutes.

Test Method:

A 3M Auto Polisher 6850A machine was modified to hold ⅛″-diameter rods in place of a fiber optic ferrule. 4″ discs of the products to be tested were punched from laboratory drawdowns and used as the test materials. ⅛″ acrylic rods were polished on the various products. The weight loss of the rod was measured every 30 seconds. The downward pressure on the rod was 32 psi. The surface speed of the rod on the test disc was 200 ft/minute.

The cumulative cut (milligrams) of the samples was measured and compared to that provided by commercial samples from 3M (3M Company). The following table summarizes the cumulative cut (in milligrams) after 30, and 60 seconds of test. It shows that the examples 11 and 12 with abrasive particles of 0.3 μm have a higher cut rate than not only the comparative commercial sample with abrasive particles of 0.3 μm, but also the comparative commercial sample with abrasive particles of 0.5 μm, which is surprising.

| | | Cut after | Cut |
|---|---|---|---|
| | Abrasive | 30 seconds | after 60 seconds |
| 3M 252X | 0.5 μm aluminum oxide | 0.05 | 0.17 |
| 3M 261X | 0.3 μm aluminum oxide | 0.085 | 0.13 |
| Example 11 | E-600 (0.3 μm aluminum | 0.325 | 0.64 |
| | oxide) | | |
| Example 12 | E-600 (0.3 μm aluminum | 0.13 | 0.24 |
| | oxide) | | |

### Example 2

### 9 Micron Aluminum Oxide Polishing Film

Preparation of the Abrasive Slurry Base:

Approximately 7.5 kg of 3 mm diameter Yttria-stabilized zirconia beads available from TOSOH were put into a one gallon ball-milling jar. 1000 grams of 9 μm aluminum oxide abrasive particles from Fujimi, 330 grams of de-ionized water, 13 gram of ACRYSOL ASE, and 4.5 grams of a 10% ammonia solution were added to the milling jar. The mixture was milled for 4 hours

Preparation of the Binder Precursor Liquid Composition:

50 grams of NEOPAC R-9000 and 50 grams of Neocryl A-662 were combined into a 200-ml beaker and stirred with a laboratory mixer for 5 minutes.

Preparation of the Abrasive Slurry:

100 grams of the abrasive slurry base was combined with 48 grams of the binder precursor liquid composition, 0.4 grams of Zonyl FSO, 24 grams of water, 2 grams of ACRYSOL ASE, 2.2 grams of a 10% ammonia solution, and 1.3 grams of NEOCRYL curing agent under gentle agitation in a 200-ml beaker. The resulting abrasive slurry was then mixed with a laboratory mixer for one hour.

Coated Abrasive Article Sample Preparation:

The abrasive slurry was coated on a 3 mil thick PET film using a #30 Meyer rod, and then dried and cured in an oven at 300° F. for 2 minutes.

The test method was the same as in example 1, except that the ⅛″ acrylic rod was replaced by a ⅛″ 304 stainless steel rod. The weight loss was measured every 4 minutes. The performance of the new coated abrasive sample was compared to the comparative sample: 3M 261X 9 μm.

The cumulative cut (in milligrams) data summarized in the following table indicates that the polishing film sample #21 has a higher polishing rate than the comparative sample with the same grit size.

| | | | | | Cut after |
|---|---|---|---|---|---|
| | | Cut after | Cut after | Cut after | 20 |
| | Abrasive | 4 minutes | 8 minutes | 12 minutes | minutes |
| Example 2 | 9 μm | 4.06 | 7.06 | 9.84 | 14.02 |
| | aluminum | | | | |
| | oxide | | | | |
| 3M 261X | 9 μm | 1.84 | 3.26 | 4.57 | 7.03 |
| | aluminum | | | | |
| | oxide | | | | |

### Example 3

### 30 Micron Aluminum Oxide Polishing Film

### Preparation of the Abrasive Slurry Base:

Approximately 7.5 kg of 3 mm diameter Yttria-stabilized zirconia beads available from TOSOH were put into a one gallon ball-milling jar. 1000 grams of 30 μm aluminum oxide abrasive particles from Fujimi, 400 grams of de-ionized water, 8 grams of ACRYSOL ASE, and 14 grams of a 10% ammonia solution were added to the milling jar. The mixture was milled for 4 hours.

Preparation of the Binder Precursor Liquid Composition:

44 grams of NEOREZ R-9679 was combined with 38 grams of Neocryl A-662. The mix was stirred for 5 minutes using a laboratory mixer.

Preparation of the Abrasive Slurry:

100 grams of the abrasive slurry base was combined with 41 grams of the binder precursor liquid composition, 0.13 grams of Zonyl FSO, 2.7 gram of water, 2.2 grams of ACRYSOL ASE, 3.4 grams of a 10% ammonia solution, 1.0 grams of NEOCRYL CURING AGENT, and 0.38 grams of BYK-024 in a 200-ml beaker under gentle agitation. The resulting abrasive slurry was then mixed with a laboratory mixer for one hour.

Coated Abrasive Article Sample Preparation:

The abrasive slurry was coated on a 3 mil thick PET film using a #42 Meyer rod, dried in an oven at 300° F. for 2 minutes, and then post cured in an oven at 300° F. for 12 hours. The test method was the same as in example 1, except that the ⅛″ acrylic rod was replaced by a ⅛″ 304 stainless steel rod. The weight loss was measured every 4 minutes. The performance of the new coated abrasive sample was compared to the comparative sample: 3M 261X 30 μm.

The cumulative cut (in milligrams) data summarized in the following table indicates that the polishing film sample #31 has a higher polishing rate than the comparative sample with the same grit size.

| | | | | | Cut after |
|---|---|---|---|---|---|
| | | Cut after | Cut after | Cut after | 20 |
| | Abrasive | 4 minutes | 8 minutes | 12 minutes | minutes |
| Example 3 | 30 μm | 15.47 | 27.95 | 39.40 | 59.12 |
| | aluminum | | | | |
| | oxide | | | | |
| 3M 261X | 30 μm | 6.98 | 13.00 | 17.97 | 27.05 |
| | aluminum | | | | |
| | oxide | | | | |

### Example 4

### 9 Micron Diamond Polishing Film

Preparation of the Abrasive Slurry Base:

Approximately 1 kg of 3 mm diameter Yttria-stabilized zirconia beads available from TOSOH were put into a 500 cc ball-milling jar. 100 grams of 9 μm diamond abrasive particles from Warren Amplex, 91 grams of de-ionized water, 0.5 grams of DISPERBIK 190, 0.15 grams of BYK-024, 0.7 gram of ACRYSOL ASE, and 1.7 grams of a 10% ammonia solution were added to the milling jar. The mixture was milled for 4 hours.

Preparation of the Binder Precursor Liquid Composition:

76 grams of NEOREZ R-9679 were combined with 70 grams of Neocryl A-662. The mix was stirred for 5 minutes using a laboratory mixer.

Preparation of the Abrasive Slurry:

100 grams of the abrasive slurry base were combined with 73 grams of the binder precursor liquid composition, 0.5 grams Zonyl FSO, 80 grams water, 4.9 grams ACRYSOL ASE, 11.5 parts grams 10% ammonia solution, and 2.0 grams NEOCRYL curing agent under gentle agitation. The resulting abrasive slurry was then mixed with a laboratory mixer for one hour.

Coated Abrasive Article Sample Preparation:

The abrasive slurry was coated on a 3 mil thick PET film using a #30 Meyer rod, dried in an oven at 300° F. for 2 minutes, and then post cured in an oven at 300° F. for 12 hours.

The test method was the same as in example 1, except that the ⅛″ acrylic rod was replaced by a ⅛″ rod of zirconia ceramic. The weight loss was measured after 8 minutes. The performance of the new coated abrasive sample was compared to the comparative samples: 3M 662—9 um from 3M and the comparative sample Mipox—9 um from MIPDX (Nihon Micro Coating Co., Ltd). In addition the surface finish of the polished surface was measured after the test was completed.

The cumulative cut (in milligrams) and the surface finish data are summarized in the following table. They indicate that the polishing film sample #41 has surprisingly similar polishing rate, but better surface finish (lower Ra and Rz) than the comparative sample with a the same grit size.

| | | | Mipox - |
|---|---|---|---|
| | Sample 4 - 9 μm | 3M 662 - 9 μm | 9 μm |
| | Diamond | Diamond | diamond |
| Cut after 8 minutes | 4.03 | 4.01 | 3.91 |
| Surface finish Ra (μm) | 0.007 | 0.013 | 0.009 |
| Surface finish Rz (μm) | 0.051 | 0.087 | 0.068 |

### Example 5

### 3 Micron Silicon Carbide Lapping Film

Preparation of the Abrasive Slurry Base

Approximately 1 kg of 3 mm diameter Yttria-stabilized zirconia beads available from TOSOH were put into a 500 cc ball-milling jar. 90 grams of 3 μm silicon carbide abrasive particles from Fujimi, 41 grams de-ionized water, 2.7 grams Disperbyk-190, 0.6 grams ACRYSOL ASE, and 0.08 grams 10% ammonia solution were combined and ball milled for 4 hours

Preparation of the Binder Precursor Liquid Composition

Epirez 5003-W55 was used as the binder precursor liquid composition.

Preparation of the Abrasive Slurry

53 grams of the abrasive slurry base was combined with 41 grams of the binder precursor liquid composition, 1.24 grams Methylimidazole, 46 grams water, 0.2 grams Zonyl FSO, 0.45 grams 10% ammonia solution, and 2 grams ACRYSOL ASE under gentle agitation. The resulting abrasive slurry was then mixed for one hour.

Coated Abrasive Article Sample Preparation:

The abrasive slurry was coated on a 3 mil thick PET film using a #30 Meyer rod, dried in an oven at 300° F. for 2 minutes, and then post cured in an oven at 300° F. for 12 hours. The test method was the same as in example 1, except that the ⅛″ acrylic rod was replaced by a ⅛″ rod of stainless steel 304. The weight loss was measured every 2 minutes. The performance of the new coated abrasive sample was compared to the comparative sample: 3M 463X—3 μm from 3M.

The cumulative cut (in milligrams) are summarized in the following table. They indicate that the polishing film sample #51 has surprisingly a better polishing rate than the comparative samples with a same grit size.

| | Cut after | Cut after | Cut after |
|---|---|---|---|
| | 2 minutes | 4 minutes | 6 minutes |
| 3M 463X - 3 μm silicon | 1.2 | 1.6 | 1.9 |
| carbide | | | |
| Example 5 - 3 μm silicon | 1.9 | 2.8 | 3.5 |
| carbide | | | |

### Example 6

### 9 Micron Silicon Carbide Polishing Film

Preparation of the Abrasive Slurry Base:

Approximately 1 kg of 3 mm diameter Yttria-stabilized zirconia beads available from TOSOH were put into a 500 cc ball-milling jar. 100 gram of 9 μm silicon carbide abrasive particles, 86 gram of de-ionized water, 2.8 gram of Tamol, and 0.12 gram of BYK-024 were added to the milling jar. The mixture was ball milled for 4 hours.

Preparation of the Binder Precursor Liquid Composition

Epirez 5003-W55 was used as the binder precursor liquid composition.

Preparation of the Abrasive Slurry:

100 grams of the abrasive slurry base was combined with 39 grams of the binder precursor liquid composition, 185 grams water, 2.1 grams Zonyl FSO, 5.2 grams ACRYSOL ASE, 1.25 grams Methylimidazole, and 0.09 grams BYK-024 under gentle agitation. The resuling abrasive slurry was then mixed with a laboratory mixer for one hour.

Coated Abrasive Article Sample Preparation:

The abrasive slurry was coated on a 3 mil thick PET film using a #30 Meyer rod, dried in an oven at 300° F. for 2 minutes, and then post cured in an oven at 300° F. for 12 hours. The coated abrasive sample had an abrasive content of approximately 67% per weight after curing.

The test method was the same as in example 1, except that the ⅛″ acrylic rod was replaced by a 304 stainless steel ⅛″ rod. The weight loss was measured every 2 minutes. The performance of the new coated abrasive sample was compared to the comparative sample: 3M 461X—9 um from 3M.

The cumulative cut (in milligrams) are summarized in the following table. They indicate that the polishing film sample #61 has a much higher polishing rate than the comparative sample.

| | Sample 6 - 9 μm | 3M 461X - 9 μm |
|---|---|---|
| Time | Silicon carbide | Silicon carbide |
| Cut after 2 minutes | 6.28 | 2.06 |
| Cut after 4 minutes | 11.36 | 3.17 |
| Cut after 6 minutes | 15.68 | 4.11 |

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. An abrasive slurry configured to form an abrasive coating on a surface of a backing, the abrasive slurry comprising:
a continuous liquid phase;
a first discontinuous phase including abrasive particles dispersed in the continuous liquid phase; and
a second discontinuous phase including binder precursor particles dispersed in the continuous liquid phase;
wherein the continuous liquid phase carries the first and second discontinuous phases.

2. The abrasive slurry of claim 1, wherein the continuous liquid phase comprises water.

3. The abrasive slurry of claim 2, wherein the continuous liquid phase comprises a water soluble organic solvent selected from the group consisting of glycol ethers, glycol ether acetates, lactates, alkylene carbonates, alcohols, acetone, methyl ethyl ketone, formamide, n-Methylpyrrolidone, 2-Pyrrolidone, Dimethylformamide, Dimethylacetamide, n-Methylformamide, tetrahydrofuran, dimethyl sulfoxide, acetonitrile, and combination thereof.

4. The abrasive slurry of claim 2, wherein the continuous liquid phase comprises at least about 60% per weight of water.

5. The abrasive slurry of claim 4, wherein the continuous liquid phase comprises at least about 90% per weight of water.

6. The abrasive slurry of claim 1, wherein the continuous liquid phase comprises an organic solvent selected from the group consisting of hydrocarbons, ketones, ethers, esters, alkylene carbonates, acetates, alcohols, glycol ethers, lactates, and combination thereof.

7. The abrasive slurry of claim 1 , wherein the first discontinuous phase is selected from the group consisting of natural diamond, synthetic diamond, cubic boron nitride, aluminum oxide, heat treated aluminum oxide, white fused aluminum oxide, black silicon carbide, green silicon carbide, titanium diboride, boron carbide, tungsten carbide, titanium carbide, garnet, fused alumina zirconia, sol gel abrasive material, silica, silicate, iron oxide, zirconium oxide, titanium dioxide, tin oxide, cerium oxide, rare earth containing ceramic materials, aluminum oxide containing ceramic material, zirconium oxide, chromium oxide, and mixtures thereof.

8. The abrasive slurry of claim 7, wherein the abrasive particles are coated with an inorganic coating, an organic coating, or combination thereof.

9. The abrasive slurry of claim 1, wherein the first discontinuous phase comprises abrasive particles with a particle size between about 5 nanometers and about 200 micrometers.

10. The abrasive slurry of claim 9, wherein the first discontinuous phase comprises abrasive particles with a particle size between about 10 nanometers and about 100 micrometers.

11. The abrasive slurry of claim 1, wherein the binder precursor particles comprise at least one of a monomer, an oligomer, a pre-polymer, and a polymer.

12. The abrasive slurry of claim 11, wherein the binder precursor is selected from the group consisting of acrylics, polyurethanes, urethane-acrylic copolymers, polyesters, alkyds, cellulosics, epoxies, phenoxy, urea formaldehyde, melamine, phenolic, polyamide, polyimide, cyanate esters, radiation curable resins, and combination thereof.

13. The abrasive slurry of claim 11, comprising a dispersion of solid binder precursor particles.

14. The abrasive slurry of claim 13, wherein the binder precursor particles are dispersed with an external surfactant, an internal surfactant grafted to the binder precursor particle, or a combination thereof.

15. The abrasive slurry of claim 13, comprising binder precursor particles formed by emulsion polymerization.

16. The abrasive slurry of claim 11, comprising an emulsion of liquid binder precursor particles.

17. The abrasive slurry of claim 11, wherein the binder precursor particles comprise at least one thermoplastic polymer selected from the group consisting of polyolefins, ethylene copolymers, polyamides, polyimide, polyesters, polyurethanes, polyacrylic, and combinations thereof,

18. The abrasive slurry of claim 11, wherein the binder precursor particles comprise at least one of a chemically reactive monomer, a chemically reactive oligomer, a chemically reactive pre-polymer, and a chemically reactive polymer.

19. The abrasive slurry of claim 18, wherein the at least one of a chemically reactive monomer, a chemically reactive oligomer, a chemically reactive pre-polymer, and a chemically reactive polymer comprises at least one functional group selected from the group consisting of vinyl, alcohol, methylol, aldehyde, ketone, phenol, ester, epoxy, acyl halide, carboxylate, amide, amine, imine, nitrile, isocyanate, cyanate ester, thiol, sulfonyl, acrylate, methacrylate, and silanol.

20. The abrasive slurry of claim 18, comprising a curing agent configured to react with the at least one of a chemically reactive monomer, a chemically reactive oligomer, a chemically reactive pre-polymer, and a chemically reactive polymer.

21. The abrasive slurry of claim 20, comprising a curing agent selected from the group consisting of metal ion crosslinkers, polyaldehydes, polyaziridines, polyisocyanates, polysulfides, imidazoles, dicyandiamines, polyamidoamines, polyamides, polyamines, functionalized silanes, functionalized siloxane, carbodiimides, peroxides, photo-initiators, and combinations thereof.

22. The abrasive slurry of claim 11, wherein the second discontinuous phase comprises binder precursor particles of:
at least about 5 nm in size; and
up to about 50 micrometers in size.

23. The abrasive slurry of claim 22, wherein the second discontinuous phase comprises binder precursor particles of:
at least about 10 nm in size; and
up to about 10 micrometers in size.

24. The abrasive slurry of claim 23, wherein the second discontinuous phase comprises binder precursor particles of:
at least about 50 nm in size; and
up to about 2 micrometers in size.

25. The abrasive slurry of claim 1, wherein the weight ratio of abrasive particles to binder precursor is at least about 0.07 and up to about 11.

26. The abrasive slurry of claim 25, wherein the weight ratio of abrasive particles to binder precursor is at least about 0.13 and up to about 7.

27. The abrasive slurry of claim 26, wherein the weight ratio of abrasive particles to binder precursor is at least about 0.20 and up to about 5.5.

28. The abrasive slurry of claim 1, wherein the weight ratio of the continuous phase to all discontinuous phases is at least about 0.4 and up to about 20.

29. The abrasive slurry of claim 28, wherein the weight ratio of the continuous phase to all discontinuous phases is at least about 0.6 and up to about 12.

30. The abrasive slurry of claim 29, wherein the weight ratio of the continuous phase to all discontinuous phases is at least about 0.8 and up to about 7.

31. The abrasive slurry of claim 1, configured to provide the abrasive coating with:
at least about 7% by weight of abrasive particles; and
up to about 94% by weight of abrasive particles.

32. The abrasive slurry of claim 31, configured to provide the abrasive coating with:
at least about 12% by weight of abrasive particles; and
up to about 88% by weight of abrasive particles.

33. The abrasive slurry of claim 32, configured to provide the abrasive coating with:
at least about 18% by weight of abrasive particles; and
up to about 85% by weight of abrasive particles.

34. The abrasive slurry of claim 1, comprising at least one rheology modifier selected from the group consisting of associative thickeners, non associative thickeners, inorganic thickeners, and combinations thereof.

35. The abrasive slurry of claim 34, comprising at least one rheology modifier selected from the group consisting of hydrophobically modified alkali acrylic emulsions, hydrophobically modified ethylene oxide urethane rheology modifiers, hybrids of hydrophobically modified alkali acrylic emulsions with hydrophobically modified ethylene oxide urethane rheology modifiers, hydrophobically modified ethoxylated aminoplast thickeners, cellulosic thickeners, acrylic thickeners, clays, fumed silica, overbased calcium sulfonate gels, castor oil derivatives, polyamides, polysaccharides, and combinations thereof.

36. The abrasive slurry of claim 1 with a viscosity from about 1 cP to about 200,000 cP.

37. The abrasive slurry of claim 36 with a viscosity from about 5 cP to about 100,000 cP.

38. The abrasive slurry of claim 37 with a viscosity from about 10 cP to about 50,000 cP.

39. The abrasive slurry of claim 1, comprising at least one dispersant selected from the group consisting of anionic, cationic, zwitterionic, nonionic surfactants, and combinations thereof.

40. The abrasive slurry of claim 1, comprising a wetting agent selected from the group consisting of hydrocarbon based surfactants, silicone surfactants, fluorosurfactants, and combinations thereof.

41. The abrasive slurry of claim 1, comprising at least one foam control agent selected from the group consisting of mineral oils, fatty oils, vegetable oils, silicone oils, glycols, alcohols, hydrophobic silica derivatives, hydrophobic organic solids, fluoro surfactants, urea, and combinations thereof.

42. The abrasive slurry of claim 1, comprising at least one adhesion promoter selected from the group consisting of silanes, titanates, zirconates, phosphates, phosphonates, phosphinates, and combinations thereof.

43. The abrasive slurry of claim 1, comprising at least one coloring agent selected from the group consisting of organic pigments, inorganic pigments, and dyes.

44. The abrasive slurry of claim 1, comprising at least one coalescing agent configured to reduce the film forming temperature of the binder precursor.

45. The abrasive slurry of claim 44, wherein the at least one coalescing agent is selected from the group consisting of glycol ethers, glycol ether acetates, lactates, alkylene carbonates, esthers, alcohols, n-methylpyrrolidone, 2-Pyrrolidone, formamide, Dimethylformamide, Dimethylacetamide, n-methylformamide, dimethyl sulfoxide, acetonitrile, and combinations thereof.

46. The abrasive slurry of claim 1, comprising at least one additive to control the pH of the slurry, selected from the group consisting of water soluble amines, organic acids, ammonia, inorganic bases, inorganic acids, and combinations thereof.

47. The abrasive slurry of claim 1, comprising at least one filler selected from the group consisting of calcium carbonate, calcium magnesium carbonate, barium sulfate, clay, silica, calcium silicate, mica, talc, diatomaceous earth, glass, calcium phosphate, wollastonite, boehmite, aluminum trihydrate, aluminum hydroxycarbonate, graphite, carbon black, bismuth oxy chloride, zinc oxide, titanium dioxide, and combinations thereof.

48. A coated abrasive article comprising:
a backing having a surface configured for being coated with an abrasive coating;
an abrasive coating disposed on the surface, the abrasive coating being formed from the abrasive slurry of claim 1; and
a coalesced second discontinuous phase in the form of a solid continuous binder phase disposed around the abrasive particles of the first discontinuous phase.

49. A coated abrasive article comprising:
a backing having a surface configured for being coated with an abrasive coating;
an abrasive coating disposed on the surface, the abrasive coating being formed from the abrasive slurry of claim 2; and
a coalesced second discontinuous phase in the form of a solid continuous binder phase disposed around the abrasive particles of the first discontinuous phase.

50. The abrasive article of claim 48, wherein the backing is selected from the group consisting of: paper, film, metallic foil, textile, cloth, nonwovens, open meshes, foams, and combinations thereof.

51. The abrasive article of claim 50, wherein the backing is a polyester film.

52. The abrasive article of claim 48, configured in the form of a disc, sheet, or roll.

53. A method of manufacturing a coated abrasive article comprising:
(a) providing a backing having a surface configured for being coated with an abrasive coating;
(b) providing an abrasive slurry including
a continuous liquid phase;
a first discontinuous phase including abrasive particles dispersed in the continuous liquid phase; and
a second discontinuous phase including binder precursor particles dispersed in the continuous liquid phase,
(c) coating the abrasive slurry onto the surface of the backing; and
(d) removing the continuous phase by evaporation.

54. The method of claim 53, wherein the continuous liquid phase comprises water.

55. The method of claim 53, further comprising coalescing the second discontinuous phase to form a solid continuous resin phase around the first discontinuous phase.

56. The method of claim 53 comprising curing the abrasive slurry coating using at least one energy source.

57. The method of claim 56, comprising transmitting energy from the energy source by convection, conduction, radiation, or combinations thereof.

58. The method of claim 57 wherein the radiation is in the form of infrared light, UV light, electron beam, or microwaves.
